(19) United States
(12) Patent Application Publication
(10) Pub. No.: US 2020/0119481 A1
(43) Pub. Date: Apr. 16, 2020

(54) INDUCTANCE CANCELING SPRING PIN CONTACT

(71) Applicant: David A. Struyk, Deephaven, MN (US)

(72) Inventor: David A. Struyk, Deephaven, MN (US)

(21) Appl. No.: 16/366,370

(22) Filed: Mar. 27, 2019

Related U.S. Application Data
(60) Provisional application No. 62/744,881, filed on Oct. 12, 2018.

(51) Int. Cl. H01R 13/24; H01R 12/71; H01R 24/40

(52) U.S. Cl. CPC H01R 13/2421; H01R 24/40; H01R 12/714

(57) ABSTRACT

An electrical spring pin contact having dual counter-rotating telescoping coaxial spring coils, where the inner spring coil has a smaller cross-sectional area than the outer spring coil, and the turns ratio of the coils has been adjusted to cancel the magnetic flux of one another, thus increasing the performance of the pin by effectively eliminating all additional inductance created by the springs. The spring pin is entirely compliant with no rigid or wearable sliding contact structure extending between ends, thereby improving durability by providing a continuous internal contact and increasing the overall compressible range of the pin.

### CROSS REFERENCE TO RELATED APPLICATIONS

This is an application for patent which is also disclosed in Provisional Application Ser. No. 62/744,881, filed on Oct. 12, 2018, entitled “Inductance Canceling Spring Pin Contact,” the benefit of the filing date of which is hereby claimed.

### FIELD OF INVENTION

The present invention relates generally to the field of electrical test contacts for use in making board-to-board or board-to-device electrical connections (usually, but not always, temporary) in a variety of different applications. More particularly, the present invention relates to electrical spring pin contacts of the foregoing type, and the elimination of inductance caused by the coil springs incorporated therein.

### BACKGROUND

The statements in this section merely provide background information related to the present disclosure and may not constitute prior art.

Billions of electrical test contacts, known generically as “pogo pins”, are manufactured and sold every year. These pins are used in electrical test fixtures, sockets, connectors, and board-to-board interconnects of an endless variety. The pogo pin, so named because of its reminiscence of a toy pogo stick, is typically thought of as a telescoping structure, consisting of a barrel, internal coil spring, and either one or two plungers. One example of such a pin is shown in FIG. 1. The plungers, usually pointed on the ends, compress the internal spring when pressed to form a connection between two electrical contacts. As it is practically impossible to make multiple electrical contacts at more than three points with rigid pins, the coil spring provides the compliance necessary to make many simultaneous connections across a wide area.

At signal frequencies even just slightly higher than DC, however, the spring coil can create unacceptably high inductance, which impedes the flow of current and degrades the signal. For this reason, the pins are designed such that the electrical current flows through the plungers and barrel, and avoids the coil altogether. This basic structure is available quite literally in thousands of designs from hundreds of manufacturers.

External and integrated spring versions are also available. Where traditional pogo pins typically utilize a machined plunger and barrel, external spring pins are usually stamped and formed, although they may be chemically milled or electroformed. In all configurations, however, the pins contain a mechanism to short circuit the current and bypass the spring coil to reduce the inductance. Whether the spring is internal or external, this shorting mechanism requires sliding or moveable contacts to allow for compliant travel. These sliding contacts provide additional points of contact which increase the overall resistance of the pin and are subject to wear. This resistance forces a small percentage of current to divert thru the coil, adding inductive impedance. As wear increases between overlapping structures, so does both the resistance and the inductance, as more current is now diverted thru the spring coil.

Sliding contacts also exhibit friction, which not only increases the contact force during compression, but can significantly decrease the contact force during expansion. In fact, pins with sliding contacts are notorious for becoming “stuck” in a compressed position, thus causing a break in electrical contact when the force compressing the pin is relieved. This limits the ability to maintain good contact as an electrical device is inserted and/or adjusted in a test fixture during testing.

Additionally, because of the overlapping structures, whether telescoping plunger and barrels, or interlocked core components of an external or integrated spring, the compressible distance, known as travel, is fundamentally limited to less than half the length of the pin. When the overlap of the components required to mechanically hold the structure together are included, the effective travel actually becomes much less than this, often only a few percent of the overall length. This available travel is what effectively limits the range of variance that an array of spring pins can accommodate, known as coplanarity.

Self-inductance of the pin is directly proportional to the length of the pin, and cannot be eliminated by the shorting structure. This is the equivalent self-inductance as if the pin were replaced by a single wire conductor of the same length. Therefore, it is advantageous to make the compressed length of the pin, known as working height, as short as possible. At higher frequencies, such as micro and millimeter wave, it is desirable to have the pins very short, often less than 1 mm in length. Unfortunately, however, the ridged components of the traditional pin severely limit its maximum compressed distance.

From the forgoing, it is evident that conventional spring pin electrical contacts have several undesirable limitations. Wearing contact surfaces increase resistance, thereby forcing additional current through the spring and increasing inductance. This resistance also varies with contact position, and is not constant with compressed distance. Additionally, such pins have overlapping contact structures which limit range of pin travel and compressible distance. These sliding contacts exhibit friction that results in varying spring contact force, which further limits available compressive forces of the pin to overcome oxides on target surface contacts. Additionally, traditional pins are not laterally compliant (flexible) and are subject to damage if not protected from lateral forces. Finally, the highest performance of any conventional spring pin is approximately 40 GHz, which limits its potential use with current technology.

Notwithstanding the above, spring pins do have advantages. While other technologies, such as elastomeric contacts, provide higher electrical performance (over 100 GHz) than spring pins, they cannot match their mechanical durability or usable temperature range. Therefore, the goal has long been to develop an electrical contact with the performance of an elastomeric contact, yet the durability of a spring pin. Given the above limitations of current spring pin designs, it is clear that a better contact design is needed.

### SUMMARY

It is evident from the forgoing discussion that most limitations of the traditional spring pin contact are the result of the sliding or moveable contact structures used to short circuit the current and bypass the spring coil. Actually, if not for the high inductance, a simple coil spring would be an ideal contact—it is durable and highly compliant, there are no internal contact points, travel is a high percentage of length, and the compressed or minimum height is very short. Unfortunately, however, a spring coil forms a nearly perfect inductor, and is thus an unworkable solution unless some means can be provided for avoiding or canceling the inductance created by current passing there through.

With the forgoing objective in mind, the present invention comprises a unique spring pin contact which eliminates all sliding or moveable contact structures used to short circuit and bypass the coil spring. To accomplish this, the present invention utilizes a dual counter-rotating coaxial spring design to effectively cancel all inductance created by the spring pin. By constructing the spring pin with counter-rotating coaxial coil springs, the inductance introduced by each of the springs can be substantially canceled by the other spring by adjusting the turns ratio, i.e., the ratio of the number of turns in one coil to the number of turns in the other coil. Since one coil is inside of the other, the coils necessarily have different diameters. Therefore, the turns ratio must necessarily be adjusted to provide equal, but opposite, magnetic fields as current passes there through. Fortunately, the inductance produced from the magnetic field of each spring changes in the same manner as the pin is compressed, and the inductances continue to cancel at any compressed distance.

Constructing the spring contact in this manner has a number of distinct advantages over conventional spring pin contacts. First, the dual coaxial spring design provides a continuous internal electrical contact, i.e., there are no sliding contacts, no internal wear and no variation in resistance with compressed distance. The dual coaxial spring design also maintains a constant and virtually friction free contact force during either compression or expansion of the pin. Therefore, it eliminates the possibility of the pin becoming “stuck” in a compressed position during use and breaking electrical connection with a contact surface.

Secondly, with no sliding contacts, there is greater than 50% travel range, thus resulting in better pin compliance, shorter total pin height and a greater range of compressive force. Finally, the dual coil structure allows for lateral flex without damage, and is suitable for use in connection with either temporary or permanent board-to-board or board-to-device electrical connections. All of this contributes to the pin's exceptional performance, which through initial simulation testing shows performance data exceeding all currently available pins by over three times.

The foregoing and additional features and advantages of the present invention will be more readily apparent from the following detailed description. It should be understood, however, that the description and specific examples herein are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a conventional “pogo pin” internal spring type electrical spring contact;

FIG. 2A is a diagrammatic view using the right-hand rule convention to show the direction of the induced magnetic flux produced by passing current through a typical coil spring in one direction;

FIG. 2B is a diagrammatic view using the right-hand rule convention to show the direction of the induced magnetic flux produced by passing current through a typical coil spring in a direction opposite to that shown in FIG. 2A;

FIG. 3 is a diagrammatic view showing the manner in which the induced magnet flux of two counter-rotating telescoping spring coils can cancel one another and produce a substantially net zero magnetic flux (and inductance) by adjusting the turns ratio of the two coils;

FIG. 4 is a side elevation of one embodiment of an improved spring pin contact which incorporates inductance canceling counter-rotating telescoping coil springs, the turns ratio of which has been adjusted to produce a substantially net zero magnetic flux

FIG. 5 is an exploded view of a spring pin contact similar to that disclosed in FIG. 4;

FIG. 6 is a vertical sectional view of a spring pin contact similar to that disclosed in FIG. 4;

FIG. 7 is a perspective view of an array of spring pin contacts, constructed in accordance with my invention, being utilized as part of an interposer between an electrical test board and a ball grid array;

FIG. 8 in an exploded view of the assembly of spring pins contacts shown in FIG. 7; and

FIG. 9 is an alternate embodiment of a spring pin contact embodying the principles of my invention that may be formed from a single continuous wire.

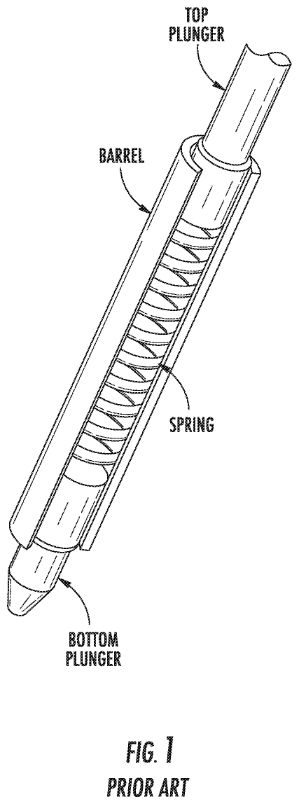

### DETAILED DESCRIPTION

The following description is merely exemplary in nature and is not intended to limit the present disclosure, application, or uses. It should be understood that throughout the drawings, corresponding reference numerals indicate like or corresponding parts and features.

In order to better understand the underlying mechanics and basis of the present invention, it is advisable to review the general principles of inductance in a cylindrical coil. Inductance of a cylindrical coil, L, is a function of the diameter, length, and the number of turns of the coil. The inductance, L, of an air core solenoid is calculated to be:

$$L = {μ}_{0} \frac{{N}^{2} A}{l} .$$

where μ₀ is the magnetic permeability of air, N is the number of turns, A is the cross-sectional area of the circular core, and l is the length.

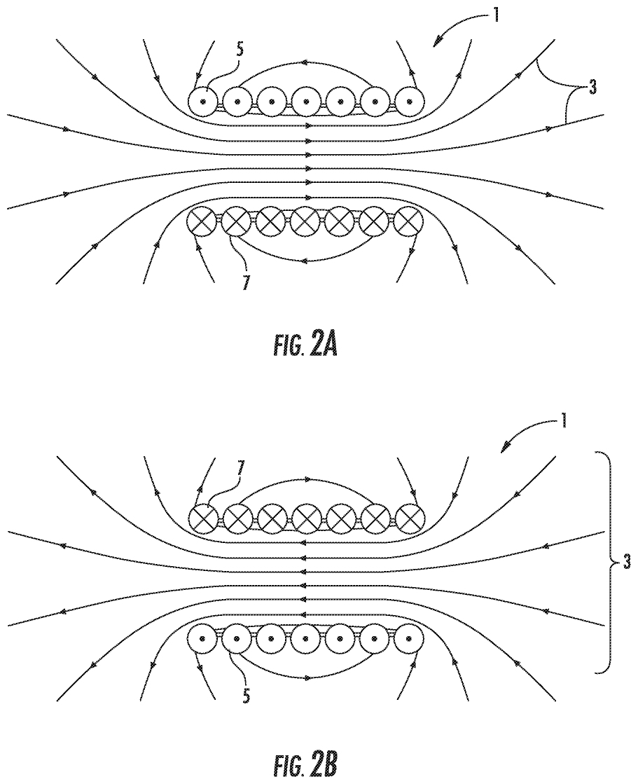

To help visualize this concept, FIG. 2A of the present drawings illustrates a cross section of a typical cylindrical coil 1 induced with an electrical current. As shown in FIG. 2A, the magnetic field (shown by arrows 3) of a cylindrical coil, or solenoid, is very much concentrated in the center of the coil 1. The circles with dots and x's are the perpendicular cross sections of coil 1. Circles 5 with dots represent coil segments where the electrical current is coming out of the page, and circles 7 with x's represent the current returning into the page. The lines with arrows 3 represent magnetic flux lines.

The direction of the magnetic field 3 follows the right-hand rule convention, i.e., if the thumb of the right hand is pointing out of the page, as in circles 5 with the dots, then the magnetic field wraps around the wire like the four fingers. This forces a concentration of flux within the center, or core, of the coil 1. If either the electrical current or direction of coil wrap is reversed, then the direction of the magnetic field 3 is also reversed. This scenario is shown in FIG. 2B.

If identical but oppositely wound coils are wound on the same core, the resulting net magnet flux will be zero, since the magnetic field of both coils is located on the same axis but in opposite magnetic polarity. If the diameters of the cores differ, however, then so must the number of coil turns in order to maintain a net zero flux. This can be seen from the above equation, where inductance L is shown to be a function of the product of the cross-sectional area A of a coil and the number of turns N².

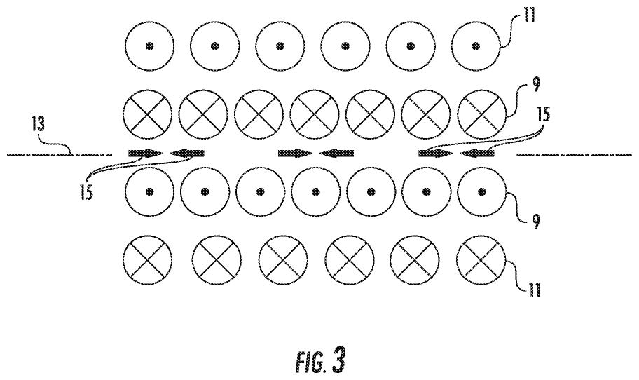

To illustrate this concept further, FIG. 3 provides a diagrammatic view similar to that of FIGS. 2A and 2B, but for a pair of spaced counter-rotating telescoping coils 9 and 11 centered on the same axis 13. Using the same convention described above, it can be seen that if the outer coil 11 wraps in the clockwise direction, and the inner coil 9 wraps in the counter clockwise direction, the same result of a substantially net zero flux (shown as opposing arrows 15) can be achieved by making appropriate adjustments to the turns ratio. In accordance with the above equation, either the number of turns of the inner coil 9 with a smaller cross-sectional area may be increased, or the outer coil 11 decreased, such that the magnetic fields produced by each coil 9 and 11 effectively cancels that of the other, thus resulting in net zero inductance.

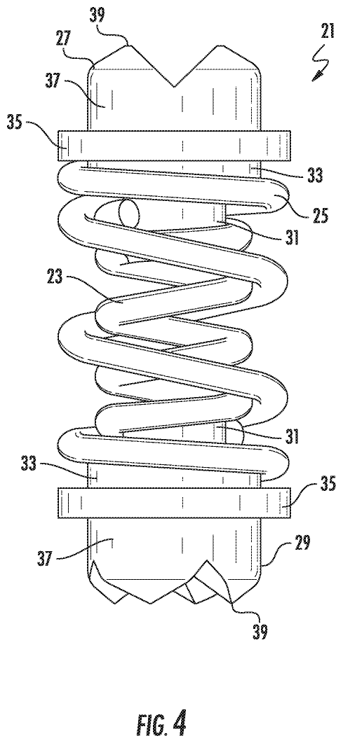

Turning now to the present invention, and with reference to FIGS. 4-6 of the drawings, one embodiment of an electrical spring pin contact 21 is disclosed which incorporates the principles on my invention. As shown, spring pin 21 includes a pair of telescoping respective inner and outer counter-rotating coaxial spring coils 23 and 25. Coils 23 and 25 are constructed of a suitable electrically conductive material, such as gold plated steel or beryllium copper, and may be bounded on opposite ends by caps 27 and 29. End caps 27 and 29 are also constructed of a similar electrically conductive material, and function to electrically couple adjacent end portions of coils 23 and 25, and provide opposing electrical surface contacts for spring pin 21.

Preferably, end caps 27 and 29 also help to maintain a major portion of the counter-rotating spring coils 23 and 25 between opposing end caps in slightly spaced relation to one another. In the embodiment disclosed, end caps 27 and 29 each include a first inner hub 31, a second outer hub 33, an intermediate shoulder 35, and an outer contact section 37. Since each end cap 27 and 29 inter-engages with coil springs 23 and 25 in the same manner, the following discussion will be limited to end cap 27, it being understood that end cap 29 is constructed and functions in an identical manner.

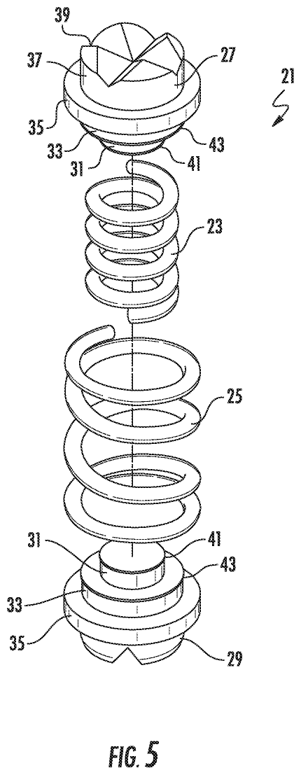

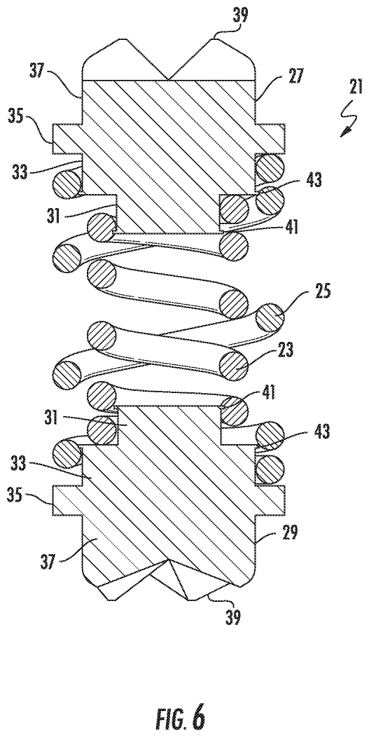

With further reference to FIGS. 5 and 6, it can be seen that the first inner hub 31 of end cap 27 has a diameter which corresponds substantially with the inner diametrical dimensions of the inner spring coil 23, and is designed to be inserted into one end of the inner spring coil 23. A relatively small peripheral flange 41 extends radially outward and circumferentially around the outer surface of hub 31 to help secure coil 23 in place on hub 31 and prevent dislodgement therefrom. Similarly, the outer hub 33 of end cap 27 has a diameter which corresponds substantially with the inner diametrical dimensions of the outer spring coil 25, and is designed to be inserted into one end thereof. As further shown in FIG. 6, a relatively small peripheral flange 43 also extends radially outward and circumferentially around the outer surface of hub 33 to help secure coil 25 in place on hub 33 and prevent dislodgement therefrom.

Therefore, as best seen in FIGS. 4 and 6, it will be appreciated that end cap 27 is constructed to permit the inner coil 23 to engage hub 31 and bear against the underside of hub 33, and the outer coil 25 to engage hub 33 and bear against the underside of shoulder 35. In this manner, the adjacent end portions of both the inner coil 23 and outer coil 25 are assured of engaging end cap 27 in an electrically conductive relation. Hubs 31 and 33 of end cap 27 also help to maintain the major portion of coils 23 and 25 in slightly spaced relation to one another.

The outer contact section 37 of end cap 27 is adapted to engage a target surface contact (not shown) for electrical conduction. The outer surface of contact section 37 may be contoured or waffled, as at 39, to help facilitate better surface connection. While the foregoing describes one possible configuration for the use of end caps 27 and 29, it should be recognized that there are myriad possible end cap designs suitable for use with spring coils 23 and 25, without departing from the scope of the invention herein.

By constructing spring pin 21 with counter-rotating coaxial inner and outer telescoping springs coils 23 and 25, respectively, the inductance introduced by each of the springs 23 and 25 upon passing a current there through can be substantially canceled by the other spring by adjusting the turns ratio. Fortunately, the inductance of each spring 23 and 25 changes in the same manner as the pin 21 is compressed, and the inductances continue to cancel at any compressed distance. Since one coil is inside of the other, the coils 23 and 25 necessarily have different diameters and cross-sectional areas. Therefore, the turns ratio may be adjusted to provide equal, but opposite, magnetic fields, which cancel the mutual inductances. Since the cross-sectional area of the outer coil 25 is greater than that of the inner coil 23, the outer coil 25 will necessarily require less turns than the inner coil 23. For instance, in the example shown in FIG. 4, the number of complete turns of the outer coil 25 is 4, while the number of turns of the inner coil 23 is 4.6. It should be understood, however, that the number of turns of each coil can be altered for any given application, as desired or necessary, provided the turns ratio is adjusted to provide a net zero flux condition.

Notably, there is no physical connection (sliding or otherwise) between end caps 27 and 29, other than the respective inner and outer spring coils 23 and 25. Accordingly, the design of the present spring pin contact 21 has remarkable advantages over the current state of the art. Since there is no overlapping structure, the pin 21 is not limited in compression like traditional pins, and can be compressed much further. This increases the travel range (greater than 50%) while allowing for the shortest possible compressed height. Also, the dual spring design provides continuous internal contact, and requires no sliding contacts. Consequently, there is little or no degradation with wear over time, and no varying resistance with compressed positon. The use of two (or more) springs can allow for higher compressive forces when necessary, and finally, the dual coil structure allows for lateral flex without damage. All of this contributes to the pins exceptional performance. Initial simulations show the 1 dB bandwidth to exceed 60 GHz on a 1 mm pitch and over 100 GHz at 0.4 mm pitch. This exceeds the performance of currently available pins by over three times.

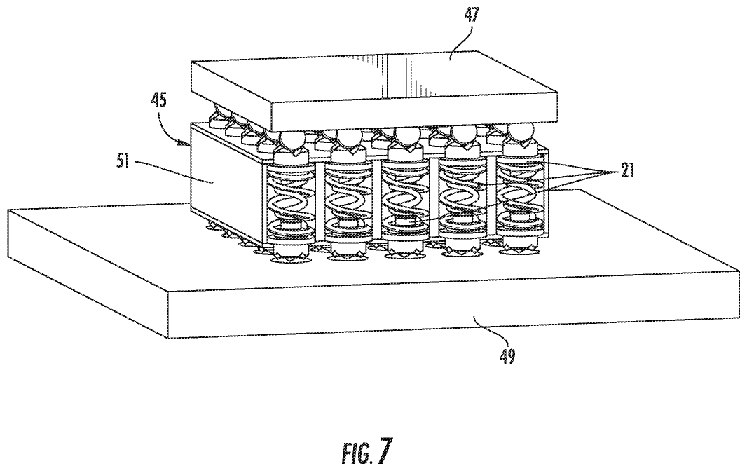

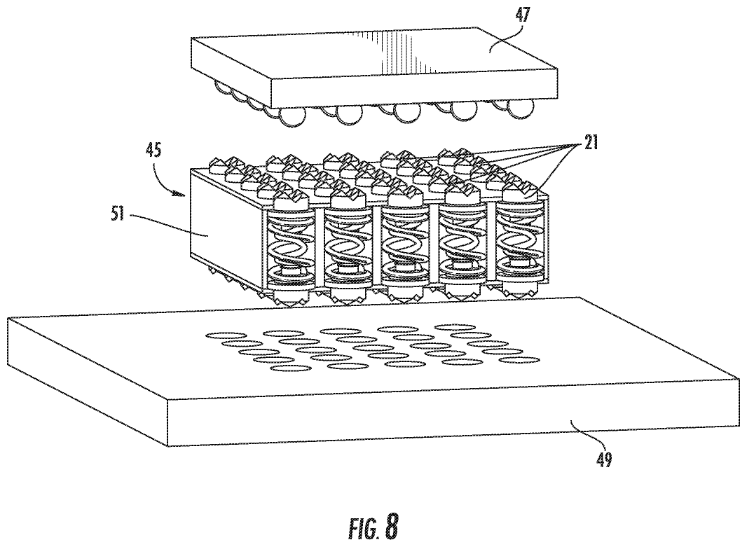

FIGS. 7 and 8 show one example of a common application where an array of spring pin contacts 21 form a part of an interposer 45 used to connect a small ball grid array (BGA) 47 to an electrical test board 49. In the present application, the interposer 45 acts as an electrical interface between the BGA 47 and the electrical test board 49. The spring pin contacts 21 of the interposer 45 are shown held in place by a guide assembly 51, which is machined out of an electrically nonconductive material. In the embodiment of FIGS. 7 and 8, it is contemplated that the guide assembly 51 may be formed from laser cut sheets of Kapton, which are laminated together in a manner as shown to retain the pins. Of course, it is contemplated that other electrically nonconductive materials could also be used for the construction of guide assembly 51, without departing from the invention herein. The interposer 45 is generally held in place and aligned to the test board 49 using a socket base and clamping fixture (not shown).

The basic structure described above includes two springs (23, 25) and two end caps (27, 29). However, as noted, it is certainly contemplated that more springs can be used as long as the turn ratios are adjusted to cancel the individual coil inductances. End caps (27, 29) can easily be machined or stamped, limited to only one, or not used at all. Indeed, cap-less configurations are contemplated, where either a continuous coil can wrap back on itself, or individual coils can be welded together.

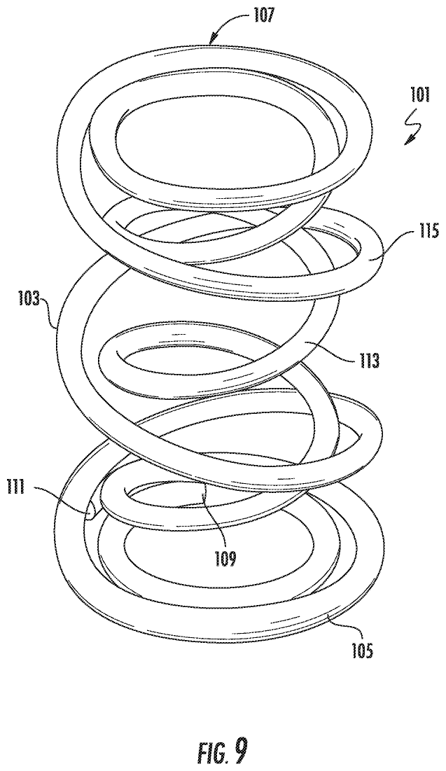

One such embodiment is shown in FIG. 9, where a cap-less spring pin contact 101 is shown. Spring pin contact 101 is formed of a single continuous section of coiled wire 103 which extends from a first lower surface contact end 105 to a second upper surface contact end 107, and back. In this embodiment, it can be seen that the continuous section of wire 103 has opposite ends 109 and 111. Starting at the innermost end 109, the section of wire 103 may be seen to form an inner coil section 113 which extends upwardly in a counterclockwise direction toward the upper surface contact end 107 of the spring pin contact 101. At the upper surface contact end 107, the wire 103 begins wrapping back downwardly around the outside of the inner coil section 113, effectively forming a larger counter-rotating outer coil section 115 of greater diameter which surrounds the inner coil section 113 and terminates at the opposite end 111 of wire 103.

The counter-rotation of the outer coil section 115 relative to the inner coil section 113 can best be seen by following the rotation of the outer coil section 115 upward from end 111 of wire 103 to the upper surface contact end 107 of the spring pin contact 101. This direction of rotation can be seen to be opposite the direction of rotation of the inner coil section 113 extending upward from end 109 to the upper surface contact end 107 of the spring pin contact 101. Further from FIG. 9, it can be seen that the inner coil section 113 of wire 103 has a smaller diameter but greater number of complete turns than the larger diameter outer coil section 115. Therefore, by electrically coupling the opposite ends 109 and 111 of wire 103 through soldering or other means, the cap-less dual coil construction of spring pin contact 101 may be completed.

It will be appreciated by those skilled in the art that the number of turns of the inner and outer coil sections 113 and 115, respectively, may be adjusted relative to one another to produce a substantially off-setting net magnetic flux condition upon inducing a change in electrical current from one end of the spring pin contact 101 to the other. In so doing, most, if not all, self-induced inductance produced by the counter-rotating coils sections 113 and 115 will be cancelled.

While it is certainly contemplated that the foregoing cap-less spring pin contact 101 could be used in applications involving temporary, as well as permanent, board-to-board and board-to-device electrical connections, the cap-less version 101 may have special adaptation for use in soldered down applications, such as “column grid arrays,” i.e., CGA's. In this regard, rather than having pointed caps at the contact ends 105 and 107 of the spring pin contact 101, such ends may be fitted or adapted with flat surfaces to accommodate permanent solder mount applications. With both contact ends 105 and 107 of the spring pin contact 101 soldered in place, the inner coil section 113 and the outer counter-rotating coil section 115 become effectively coupled electronically at opposite ends. Here again, the dual coil construction provides substantial benefits over solid pin CGA's in that, amongst other things, it allows for lateral flex without damage. Whether used with temporary or permanent board-to-board and board-to-device electrical connections, cap-less versions of the spring pin contact can significantly reduce cost, although all embodiments of the present invention can take advantage of automated assembly.

Certain terminology is used herein for purposes of reference only, and thus is not intended to be limiting. For example, terms such as “upper”, “lower”, “above”, “below”, “top”, “bottom”, “upward”, “downward”, “rearward”, and “forward” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The disclosure herein is intended to be merely exemplary in nature and, thus, variations that do not depart from the gist of the disclosure are intended to be within the scope of the disclosure. Such variations are not to be regarded as a departure from the spirit and scope of the disclosure, which comprises the matter shown and described herein, and set forth in the appended claims.

1. An electrical spring pin contact, comprising:
(a) a first spring coil being formed of an electrically conductive material, and having opposite ends and an open central core;
(b) a second spring coil being formed of an electrically conductive material, and having opposite ends and an open central core,
(c) the second spring coil being formed in counter-rotating relation to the first spring coil and being sized to be telescopically received within the core of the first spring coil, the opposite ends of the second spring coil being electrically coupled to the first spring coil; and
(d) the number of turns of the first spring coil and the second spring coil being established relative to one another such that a magnetic field produced by electrical current passing through one cancels at least a portion of a magnetic field produced by electrical current passing through the other.

2. The electrical spring pin contact set forth in claim 1, wherein the magnetic field produced in the second spring coil substantially cancels the magnetic field produced in the first spring coil, thus producing a substantially net zero inductance overall.

3. The electrical spring pin contact set forth in claim 1, wherein each of the opposite ends of the second spring coil are electrically coupled with an adjacent one of the opposite ends of the first spring coil.

4. The electrical spring pin contact set forth in claim 3, wherein at least one of the opposite ends of the first spring coil engages an electrically conductive end cap.

5. The electrical spring pin contact set forth in claim 3, wherein one of the ends of the second spring coil and its adjacent end of the first spring coil are connected electrically to a first electrically conductive end cap, and the opposite end of the second spring coil and its adjacent end of the first spring coil are connected electrically to a second electrically conductive end cap.

6. The electrical spring pin contact set forth in claim 5, wherein the first and second end caps each include a central hub which extends within the core of at least the first spring coil.

7. The electrical spring pin contact set forth in claim 6, wherein the central hub of each of the first and second end caps includes a first hub portion adapted to be received within the core of the first spring coil in electrical engagement therewith, and a second smaller hub portion adapted to be received within the core of the second spring coil in electrical engagement therewith.

8. The electrical spring pin contact set forth in claim 4, wherein the end cap includes a contact surface extending in a plane generally perpendicular to an axis extending between the opposite ends of the first spring, where at least a part of the contact surface tapers outwardly to a peak.

9. The electrical spring pin contact set forth in claim 1, wherein a major portion of the length of the first spring coil and the second spring coil between the opposite ends thereof is maintained in slightly spaced relation relative to one another.

10. The electrical spring pin contact set forth in claim 1, including an array of additional spring pin contacts constructed in the same manner, wherein at least one of the opposite ends of the first spring coil of each of the spring pin contacts is in engagement with an electrical circuit board.

11. The electrical spring pin contact set forth in claim 4, including an array of additional spring pin contacts constructed in the same manner, wherein at least one end cap of each of the spring pin contacts is in engagement with an electrical circuit board.

12. The electrical spring pin contact set forth in claim 1, wherein the first spring coil and the second spring coil are formed of a single continuous section of electrically conductive material.

13. The electrical spring pin contact set forth in claim 12, wherein the first spring coil wraps back around the second spring coil.

14. An electrical spring pin contact, comprising:
(a) a first spring coil being formed of an electrically conductive material, and having opposite ends and an open central core;
(b) a second spring coil being formed of an electrically conductive material, and having opposite ends and an open central core,
(c) the second spring coil being formed in counter-rotating relation to the first spring coil and being disposed telescopically within the core of the first spring coil;
(d) the first spring coil and the second spring coil being disposed in generally coaxial relation to one another, and each of the ends of the second spring coil being located adjacent to one of the ends of the first spring coil;
(e) each of the adjacent ends of the first and second spring coils being electrically coupled together by a separate contact member; and
(f) the number of turns of the first spring coil and the second spring coil being determined relative to one another, such that a magnetic field produced by electrical current passing through one substantially cancels a magnetic field produced by electrical current passing through the other, thus producing a substantially net zero inductance between the first and second spring coils.

15. The electrical spring pin contact set forth in claim 14, wherein the contact member at each of the opposing ends of the first spring coil is comprised of an electrically conductive end cap having a central hub which extends into the core of the first spring coil in engaging relation therewith.

16. The electrical spring pin contact set forth in claim 14, wherein a substantial portion of the length of the first spring coil and the second spring coil between the opposite ends thereof is maintained in slightly spaced relation relative to one another.

17. The electrical spring pin contact set forth in claim 14, including an array of additional spring pin contacts constructed in the same manner, wherein at least one of the electrically conductive contact members of each of the spring pin contacts has a contact surface disposed in engagement with an electrical circuit board.

18. The electrical spring pin contact set forth in claim 17, wherein one of the electrically conductive contact members of each of the spring pin contacts has a free contact surface which tapers outwardly to a peak.

19. An electrical spring pin contact, comprising:
(a) a first spring coil being formed of an electrically conductive material, and having opposite ends and an open central core;
(b) a second spring coil being formed of an electrically conductive material, and having opposite ends and an open central core,
(c) the second spring coil being formed in counter-rotating relation to the first spring coil and being sized to be telescopically received within the core of the first spring coil, wherein a major portion of the length of the first spring coil and the second spring coil between the opposite ends thereof are maintained in slightly spaced relation relative to one another, and each of the opposite ends of the second spring coil being electrically coupled with an adjacent one of the opposite ends of the first outer spring coil; and
(d) the number of turns of the first spring coil and the second spring coil being adjusted relative to one another such that a magnetic field produced by electrical current passing through one substantially cancels a magnetic field produced by electrical current passing through the other, thus producing a substantially net zero inductance overall.

20. The electrical spring pin contact set forth in claim 19, wherein each of the adjacent ends of the first and second spring coils carries an electrically conductive end cap.

21. The electrical spring pin contact set forth in claim 20, wherein each end cap includes a central hub with a first hub portion adapted to be received within the core of the first spring coil in electrical engagement therewith, and a second smaller hub portion adapted to be received within the core of the second spring coil in electrical engagement therewith.

22. The electrical spring pin contact set forth in claim 20, including an array of additional spring pin contacts constructed in the same manner and carried in a guide assembly formed of an electrically nonconductive material.

23. The electrical spring pin contact set forth in claim 19, wherein the first spring coil and the second spring coil are formed of a single continuous section of electrically conductive material.

24. The electrical spring pin contact set forth in claim 23, wherein the first spring coil wraps back around the second spring coil.
